(19) United States
(12) Patent Application Publication
(10) Pub. No.: US 2022/0218569 A1
(43) Pub. Date: Jul. 14, 2022

(54) Nut for affixing a nipple to a baby bottle

(71) Applicant: Artsana S.p.A., Villa Guardia CO (IT)

(72) Inventor: Francesco GATTI, Villa Guardia CO (IT)

(21) Appl. No.: 17/610,740

(22) PCT Filed: May 11, 2020
(86) PCT No.: PCT/IB2020/054434

§ 371 Date: Nov. 12, 2021

(30) Foreign Application Priority Data
May 15, 2019 (IT) 102019000006870

(51) Int. Cl. A61J 11/04; A61J 9/04; A61J 11/00

(52) U.S. Cl. CPC A61J 11/045; A61J 11/008; A61J 9/04

(57) ABSTRACT

A nut for ensuring compatibility of a nipple having an anti-colic valve affixed to a baby bottle having a bottom vent and a mouth; the nut comprises a flange which has a central opening for receiving the nipple extending therethrough, the central opening has an edge configured to engage in an annular groove of the nipple, the nipple also comprises a flange;
the nut comprises means for inhibiting the anti-colic valve which comprise:
   a first annular rib formed on the inner surface of the flange, which is configured to abut the flange of the nipple between the anti-colic valve and the edge of the central opening of the flange,
   a second rib, concentric with the first rib, which is configured to provide a hydraulic seal between the flange of the nipple and the mouth of the baby bottle,
   a depression interposed between the first rib and the second rib, which is configured to abut against the anti-colic valve of the nipple when the nut and the nipple are coupled together and are applied to a baby bottle to inhibit the anti-colic valve.

### FIELD OF THE INVENTION

The present invention relates to a nut for affixing a nipple to a bottom-vented baby bottle, which has means for also ensuring compatibility with a nipple having an anti-colic valve.

### DISCUSSION OF THE RELATED ART

In the field of baby bottles, a nipple affixed to a closed-bottom baby bottle is equipped with a special valve, conventionally known as anti-colic valve, in view of restricting air suction therefrom.

From a strictly technical and functional point of view, this valve is intended to compensate for the negative pressure generated inside the bottle as milk is being sucked by the baby by creating a passage for air between the interior of the baby bottle and the outside environment.

Conventionally, this valve is placed on the flange of the nipple by means of which it is mounted to the cover that closes the baby bottle containing the milk to be sucked.

If a nipple of the above-mentioned type is used in a milk-containing baby bottle having a vent valve at the bottom, the need arises of inhibiting the operation of the anti-colic valve located in the flange of the nipple.

### OBJECT OF THE INVENTION

Therefore, the object of the present invention is to make the anti-colic valve ineffective, when the nipple with the anti-colic valve is used on a milk-containing baby bottle having a vent valve at the bottom.

This object is fulfilled by a nut for affixing the nipple to a baby bottle, characterized according to claim 1, as further described below.

### Advantages of the Invention

The present invention provides a nut that can ensure compatibility of a nipple having an anti-colic valve with a baby bottle having a bottom vent valve.

### LIST OF DRAWINGS

The invention will be now described in greater detail with reference to one embodiment thereof, given by way of illustration and without limitation, and shown in the annexed drawings, in which:

FIG. 1 shows a cross-sectional view of a baby bottle having a conventional vent valve at the bottom of the milk-containing bottle and a nut for affixing the nipple;

FIG. 2 shows a partial cross-sectional view of a nut for affixing a nipple having an anti-colic valve, with means for inhibiting the latter;

FIG. 3 shows a partial magnified view of the cross section of a nut for affixing the nipple, with means for inhibiting the anti-colic valve.

### DETAILED DESCRIPTION

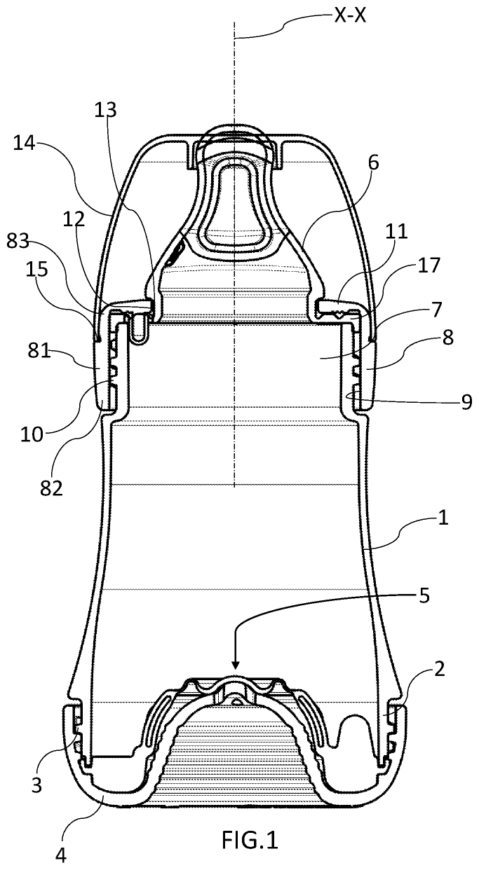

Referring to the above-mentioned drawings and in particular to FIG. 1, a baby bottle is designated by numeral 1. Preferably, this bottle 1 is configured to contain milk to be administered to babies.

A bottom 4 is removably connected to the lower end 2 of the bottle 1, e.g. by means of screw threads 3.

The bottom 4 is in turn equipped with a conventional device for venting the bottle 1, generally referenced 5, which is intended to balance the pressure inside the bottle 1, as milk is being sucked by the baby through a nipple, generally referenced 6.

Still referring to FIG. 1, the nipple 6 is shown affixed to the mouth 7 of the baby bottle 1 by means of a nut 8.

The nut 8 comprises a tubular sleeve 81 which extends between a lower portion 82 and an opposite upper portion 83 along an extension axis X-X.

Such nut 8 has a flange 11 with a central opening 12 for receiving the nipple 6 extending therethrough. The latter is locked against the nut 8 because the edge of the opening 12 engages in the annular groove 13 of the nipple 6.

The flange 11 projects out of the upper portion 83 of the tubular sleeve 81 toward the interior of the nut 8. In other words, the flange 11 is transverse to the tubular sleeve 81.

Preferably, the tubular sleeve 81 of the nut 8 comprises a female thread 9 configured for reversible connection with a male thread 10 of the mouth 7 of the bottle 1.

In addition, the nut 8 comprises an annular recess 15 configured for detachable connection with a protective cover 14. In other words, in order to protect the nipple 6 when not in use, the protective cover 14 is conventionally placed on top of the bottle at the annular recess 15 of the ring 8.

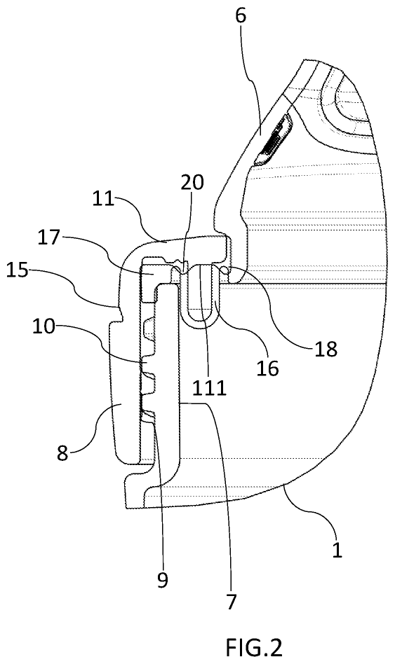

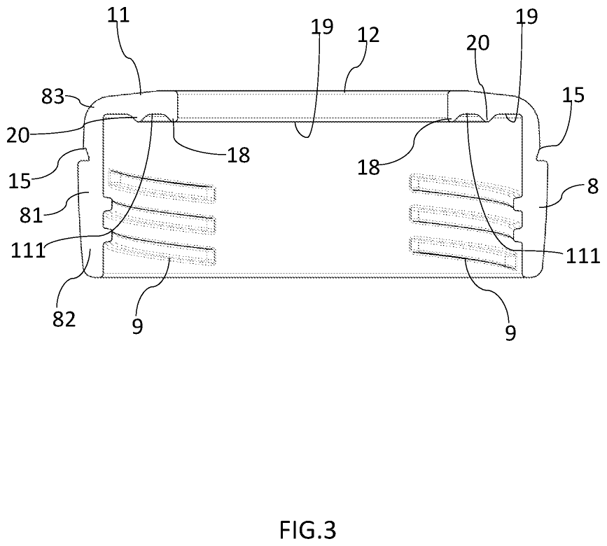

Referring to FIGS. 2 and 3, if a nipple 6 to be affixed to the bottle 1 is of the type equipped with an anti-colic valve, generally referenced 16 and formed in the flange 17 of the nipple 6, the nut 8 comprises means for inhibiting the anti-colic valve 16.

These means for inhibiting the anti-colic valve 16 comprise a first annular rib 18, formed on the inner wall 19 of the flange 11 of the nut 8. This first annular rib 18 inhibits the passage of air allowed by the anti-colic valve 16.

With the nut 8 screwed onto the mouth 7, the first annular rib 18 abutting the wall of said flange 17 of the nipple 6 that faces the interior of the bottle 1, between said anti-colic valve 16 and the edge of the central opening 12 of the flange 11.

Thus, the first annular rib 18 breaks the connection between the interior of the bottle 1 and the outside environment around the nipple 6.

The means for inhibiting the anti-colic valve 16 further comprise a second rib, referenced 20 in FIGS. 2 and 3. This second rib 20, which is concentric with the first rib 18, provides a hydraulic seal between the flange 17 and the mouth 7.

The means for inhibiting the anti-colic valve further comprise a depression 111 interposed between the first rib 18 and the second rib 20. In operation, i.e. when the nut 8 and the nipple 6 are applied to a baby bottle 1, the depression 111 abuts against the anti-colic valve 16. In other words, in operation, the anti-colic valve 16 is interposed between the first rib 18 and the second rib 20.

1. A nut configured to ensure compatibility of a nipple having an anti-colic valve affixed to a baby bottle having a bottom vent, said baby bottle having a mouth, said nut comprising a flange with a central opening for receiving said nipple extending therethrough, said central opening having an edge configured to engage in an annular groove of the nipple, the nipple also having a flange;
said nut being characterized by comprising means for inhibiting the anti-colic valve, comprising:
a first annular rib formed on the inner surface of the flange, said first annular rib being configured to abut the flange of the nipple between said anti-colic valve and the edge of the central opening of the flange,
a second rib, concentric with said first rib, said second rib being configured to provide a hydraulic seal between the flange of the nipple and the mouth of said baby bottle,
a depression interposed between the first rib and the second rib, said depression being configured to abut against the anti-colic valve of the nipple when the nut and the nipple are coupled together and are applied to a baby bottle to inhibit said anti-colic valve.

2. A nut as claimed in claim 1, comprising a tubular sleeve extending between a lower portion and an opposite upper portion along an extension axis, said flange projecting out of the upper portion of the tubular sleeve toward the interior of the nut.

3. A nut as claimed in claim 2, wherein the tubular sleeve of the nut comprises a female thread configured for reversible connection with a male thread of the mouth of the bottle.

4. A nut as claimed in claim 1, comprising an annular recess configured for detachable connection with a protective cover.

5. A nut-nipple assembly, comprising:
a nipple comprising a base flange, said nipple having an anti-colic valve at the flange,
a nut comprising a flange having a central opening for receiving said nipple extending therethrough, the central opening having an edge and the nipple having an annular groove, said edge of said nut being engaged in the annular groove of the nipple,
said nut being characterized by comprising means for inhibiting the anti-colic valve, comprising:
a first annular rib formed on the inner surface of the flange, said first annular rib abutting the flange of the nipple between said anti-colic valve and the edge of the central opening,
a second rib, concentric with said first rib, said second rib being configured to provide a hydraulic seal between the flange of the nipple and a mouth of a baby bottle,
a depression interposed between the first rib and the second rib, said depression abutting the anti-colic valve of the nipple when the nut and the nipple are coupled together to inhibit said anti-colic valve.

6. A baby bottle comprising:
a bottle with a bottom vent, configured to contain milk to be administered to a baby, said bottle having a mouth,
a ring-nipple assembly as claimed in claim 5, said assembly being coupled to the bottle at the mouth.
